(19) United States
(12) Patent Application Publication
(10) Pub. No.: US 2011/0321009 A1
(43) Pub. Date: Dec. 29, 2011

(54) IMPLEMENTING ENCRYPTION VIA ASPECT ORIENTED PROGRAMMING

(75) Inventor: Joseph David Shulmister, JR., Plant City, FL (US)

(73) Assignee: VERIZON PATENT AND LICENSING INC., Basking Ridge, NJ (US)

(21) Appl. No.: 12/824,285

(22) Filed: Jun. 28, 2010

(51) Int. Cl. G06F 9/45; G06F 9/44

(52) U.S. Cl. 717/116; 717/140

(57) ABSTRACT

A device may include a processor. The processor may be configured to read an aspect, and identify, within a program, code for instantiating an object output stream object based on the aspect. In addition, the processor may be configured to replace, within the program, the code for instantiating the object output stream object with code for instantiating secure object output stream object. Furthermore, the processor may be configured to generate a compiled program from code obtained by replacing, in the program, the code for instantiating the object output stream object with the code for instantiating the secure object output stream object. The processor may be configured to write the compiled program to a file.

### BACKGROUND

A programming language may be well suited for implementing programs that perform particular types of tasks. For example, the c language allows a programmer to easily craft programs that are optimized for speed. The C++ and Java programming languages allow a programmer to easily enforce program modularity and increase re-usability of code. Practical Extraction and Reporting Language (Perl) permits a programmer to easily write programs for detecting symbol patterns (e.g., sequence of characters, numbers, etc.), for example, in text and/or strings.

### BRIEF DESCRIPTION OF THE DRAWINGS

FIG. 1 illustrates an exemplary network in which concepts described herein may be implemented;

FIG. 2 is a block diagram of an exemplary network device of FIG. 1;

FIG. 3 is a functional block diagram of the network device of FIG. 2;

FIG. 4 depicts exemplary classes that may be implemented in Java;

FIG. 5 shows exemplary source code for the Line and Pixel classes of FIG. 5;

FIG. 6 shows exemplary changes to the Line and Pixel classes of FIG. 5, for updating Line objects and Pixel objects that are displayed in a graphical window;

FIG. 7 shows an exemplary CheckStateChange aspect implemented in AspectJ;

FIG. 8 is a block diagram of exemplary components of the exemplary encryption aspect of FIG. 3;

FIG. 9 shows the encryption aspect of FIG. 8 implemented in AspectJ;

FIG. 10A shows exemplary details of an exemplary around advice of FIG. 9;

FIG. 10B shows exemplary details of another exemplary around advice of FIG. 9;

FIG. 11 is a flow diagram of an exemplary process that is performed by an exemplary method for obtaining a cipher;

FIG. 12 shows an exemplary Java program that implements the exemplary process of FIG. 11;

FIG. 13 is a flow diagram of an exemplary process for performing an act in the exemplary process of FIG. 11; and

FIG. 14 shows an exemplary Java program that implements the exemplary process of FIG. 13.

### DETAILED DESCRIPTION

The following detailed description refers to the accompanying drawings. The same reference numbers in different drawings may identify the same or similar elements. As used herein, the term “program” may include a source program, object program, executable program, component, application, interpreted program, bytecode, script, and/or another form of instructions for execution by one or more processors (e.g., microprocessors).

As used herein, the term “object” may include members (e.g., constituent data of which the object is composed) and methods (e.g., a unit of program that is associated with the object). A class definition, which may be written by a programmer, may describe or specify what members and methods an object of the class includes.

In addition, the term “serialization” may include converting an object into a stream of bytes from which the object can be reconstructed (e.g., by a program). The term “de-serialization” may include constructing an object from serialized data.

As described below, a program that serializes or de-serializes data may be rendered secure by extending the program with an encryption module defined in an aspect-oriented programming (AOP) language. In the following, the encryption module may be referred to as the “AOP encryption module” or “AOP encryption aspect.”

Extending the program with the AOP encryption aspect/module can obviate a typical problem in the object-oriented programming paradigm. For example, in an object-oriented programming environment, to add an encryption method that is common to a set of hierarchically unrelated classes, the programmer may be required to edit and compile the classes. When the number of classes to be modified is large, the upkeep and/or maintenance of the program can be cumbersome and expensive.

In contrast, to extend the program in accordance with the AOP paradigm, the programmer may specify the required encryption in a single aspect/module (i.e., the AOP encryption module). Compiling the extended program with an AOP compiler may then generate a secure version of the program. Consequently, adopting the AOP paradigm to implement the encryption may be less cumbersome and expensive than relying solely on the object-oriented programming approach.

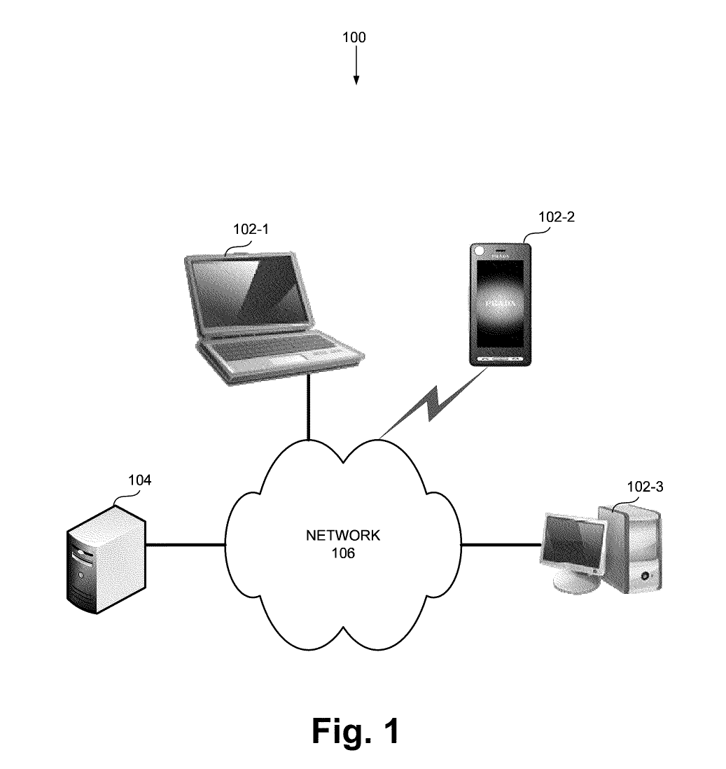

FIG. 1 illustrates an exemplary network 100 in which concepts described herein may be implemented. As shown, network 100 may include a variety of devices, such as, for example, user devices 102-1 through 102-3 (e.g., laptop computer 102-1, smart phone 102-2, and personal computer 102-3) (herein referred to as user devices 102 or user device 102), server device 104, and network 106. For simplicity, FIG. 1 does not show other network elements that may be present in network 100, such as, for example, routers, switches, bridges, gateways, etc., or other types of user devices, such as, for example, a tablet computer; mobile telephone; cellular phone; personal communications system (PCS) terminal that may combine a cellular radiotelephone with data processing, facsimile, and/or data communications capabilities; a personal digital assistant (PDA) that can include a telephone; a gaming device or console; a peripheral (e.g., wireless headphone); a digital camera; a digital video camera; etc.

User device 102 may provide communication and/or computational services (e.g., emailing, texting, placing a phone call, receiving a call, etc.) to a user. In some implementations, when user device 102 communicates with another device (e.g., laptop computer 102-1 communicates with server device 104 or personal computer 102-3), user device 102 may transmit or receive serialized/de-serialized objects.

Server device 104 may include applications for providing network services. For example, in one implementation, server device 104 may host web servers, application servers, databases, email servers (e.g., Sendmail, Microsoft Exchange, etc.).

In addition, server device 104 may provide a software development environment (e.g., Integrated Development Environment (IDE) application, software editor, compiler, etc.). In one implementation, server device 104 may include an AOP encryption module, AOP compiler and/or an Aspect-Oriented program editor.

Network 106 may include one or more wired and/or wireless networks that are capable of exchanging information, such as voice, video, documents, multimedia, text, etc. For example, network 106 may include one or more public switched telephone networks (PSTNs) or another type of switched network. Network 106 may also include a number of transmission towers for receiving wireless signals and forwarding the signals toward the intended destination. Network 106 may further include one or more packet switched networks, such as an Internet protocol (IP) based network, a local area network (LAN), a wide area network (WAN), a personal area network (PAN), an intranet, the Internet, or another type of network that is capable of exchanging information. In FIG. 1, devices 102 and 104 may communicate directly with any other device or via network 106.

Depending on the implementation, network 100 may include additional, fewer, different, or different arrangement of devices than those illustrated in FIG. 1. For example, in one implementation, network 100 may include additional user devices, server devices, etc. In a different implementation, personal computer 102-3 may include functionalities of server device 104, and may host a web server.

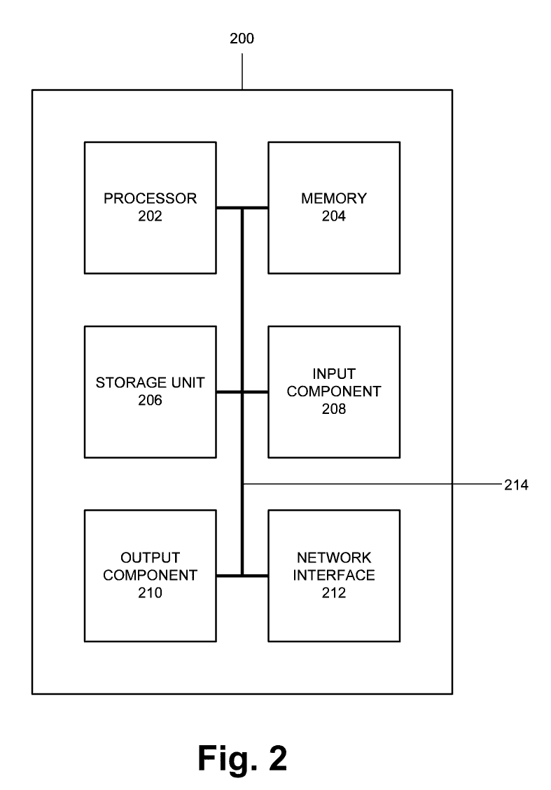

FIG. 2 is a block diagram of an exemplary network device 200, which may correspond to user device 102 or server device 104. As shown, network device 200 may include a processor 202, memory 204, storage unit 206, input component 208, output component 210, network interface 212, and communication path 214. In different implementations, network device 200 may include additional, fewer, different, or different arrangement of components than the ones illustrated in FIG. 1. For example, network device 200 may include line interfaces, such as interfaces for receiving and forwarding data.

Processor 202 may include a processor, a microprocessor, an Application Specific Integrated Circuit (ASIC), a Field Programmable Gate Array (FPGA), and/or other processing logic capable of controlling network device 200. Memory 204 may include static memory, such as read only memory (ROM), and/or dynamic memory, such as random access memory (RAM), or onboard cache, for storing data and machine-readable instructions (e.g., programs, scripts, etc.). Storage unit 206 may include a floppy disk, CD ROM, CD read/write (R/W) disc, and/or flash memory, as well as other types of storage devices for storing data and/or machine-readable instructions (e.g., a program, script, etc.).

Input component 208 and output component 210 may provide input and output from/to a user to/from network device 200. Input/output components 208 and 210 may include a display screen, a keyboard, a mouse, a speaker, a microphone, a camera, a DVD reader, Universal Serial Bus (USB) lines, and/or other types of components for converting physical events or phenomena to and/or from signals that pertain to network device 200.

Network interface 212 may include a transceiver (e.g., a transmitter or receiver) for network device 200 to communicate with other devices and/or systems. For example, via network interface 212, network device 200 may communicate over a network, such as the Internet, an intranet, a terrestrial wireless network (e.g., a WLAN, WiFi, WiMax, etc.), a satellite-based network, etc. Network interface 212 may include a modem, an Ethernet interface to a LAN, and/or an interface/connection for connecting network device 200 to other devices (e.g., a Bluetooth interface).

Communication path 214 may provide an interface through which components of network device 200 can communicate with one another.

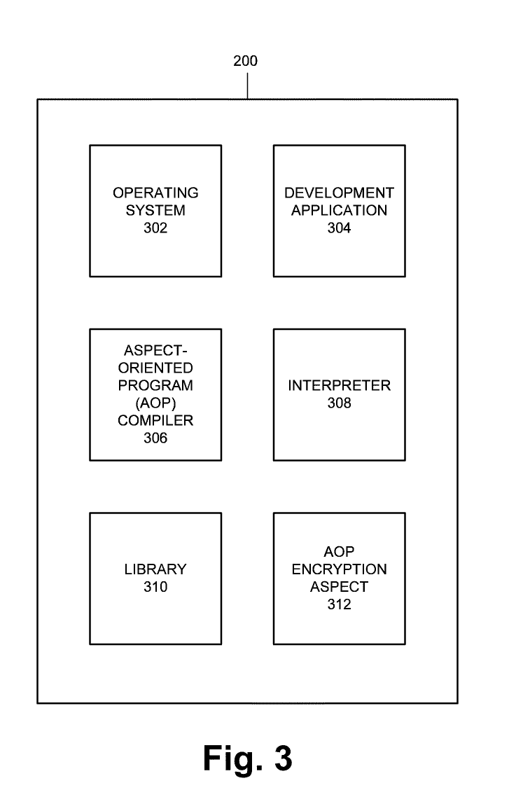

FIG. 3 is a functional block diagram of network device 200. As shown, network device 200 may include an operating system 302, development application 304, AOP compiler 306, interpreter 308, library 310, and AOP encryption aspect. Depending on the implementation, network device 200 may include additional, fewer different, or different arrangement of functional components than those illustrated in FIG. 3. For example, in some implementations, network device 200 may include server applications, such as a web server, application server, databases, etc. In other implementations, functionalities of AOP compiler 306 may be included in development application 304.

Operating system 302 may manage resources of network device 200. For example, operating system 302 may manage file systems, processes, threads, memory, drivers, communication resources, etc. For example, upon receiving a request from development application 304, operating system 302 may load an executable program in memory 204 and run the program. In another example, operating system 302 may run interpreter 308 upon receiving a user command (e.g., via a console).

Development application 304 may include, for example, a program editor, program tracer, debugger, and/or other combination of tools for software development. A programmer may perform many tasks that are associated with software development via development application 304, such as editing, tracing, debugging, compiling, designing graphical user interface (GUI) components, etc.

In some implementations, development application 304 may be configured to work in conjunction with AOP compiler 306. In such implementations, after writing source code, a programmer may trigger AOP compiler 306 from within development application 304. Furthermore, from within development application 304, the programmer may trace or run the compiled code, or through another application, such as interpreter 308.

AOP compiler 306 may scan and compile source code into object code, executable code, bytecode, etc. The object code may include binaries that can be run directly via operating system 302 (e.g., load the program into memory 202 and execute the instructions in memory 202) on network device 200 or code that may be run on interpreter 308 (e.g., bytecode for a Java virtual machine). AOP compiler 306 may include, for example, AspectBench compiler, Aspect-oriented C Compiler (ACC), Aspect-oriented Framework C#, linker (e.g., linker for linking object code into a single executable program), etc.

In the following, AOP compiler 306 will be described in terms of AspectJ compiler. AspectJ compiler may be used to compile programs that are written in AspectJ, which is an AOP language derived from Java. AspectJ extends the Java syntax to include additional keywords (e.g., aspect, around, pointcut, within, etc.) and associated syntactic structures.

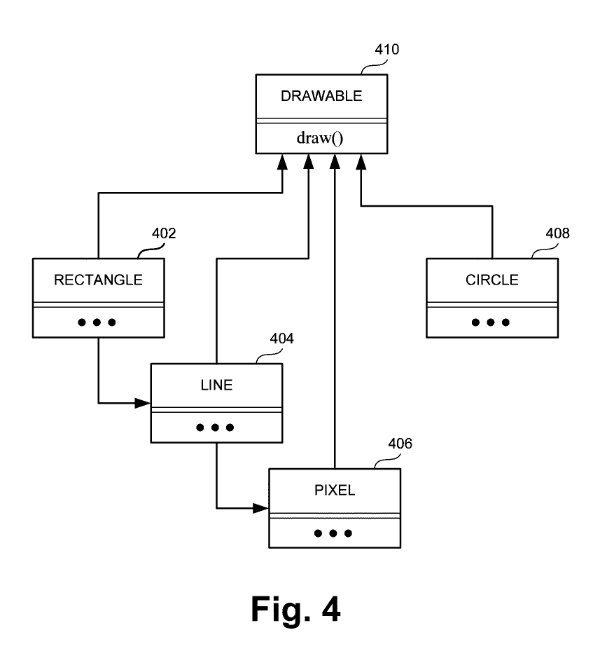

In Java, as in other object-oriented languages (OOLs), a program may be implemented in terms of class definitions. For example, assume that a programmer David is writing a graphical program for manipulating geometrical shapes. FIG. 4 shows exemplary classes David may write in Java for the graphical program. As shown, the graphical program includes a Rectangle class 402, Line class 404, Pixel class 406, Circle class 408, and Drawable class 410. Each of classes 402 through 408 may be an extension of Drawable class 410, and may represent a graphical component that can be displayed by the program.

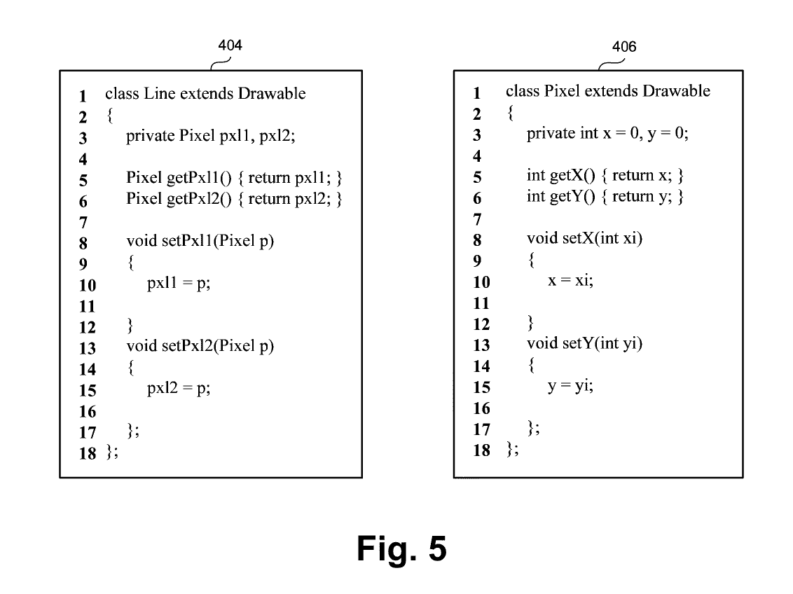

FIG. 5 shows exemplary source code for Line class 404 and Pixel class 406 that are written in Java. As shown, Line class 404 may include members pxl1 and pxl2 (e.g., line 3 of Line class 404 in FIG. 5) of type Pixel. Line class 404 also may include setPxl1(Pixel p) and setPxl2(Pixel p) methods (see lines 8-12 and lines 13-17 of Line class 404). Pxl1 and pxl2 may characterize a line (e.g., two points may define a line). SetPxl1(Pixel p) and setPxl2(Pixel p) methods may allow methods that are not members/methods of Line class 404 to modify pxl1 and pxl2.

In addition, as shown in FIG. 5, Pixel class 406 may include members x and y (line 3 of Pixel class 406) of the type integer. Pixel class 406 may also include setX(int x) and setY(int y) methods (see lines 8-12 and lines 13-17 of Pixel class 406). X and y may define a pixel (e.g., a point is defined by its coordinates). SetX(int x) and setY(int y) methods may permit methods that are not members/methods of Pixel class 406 to modify a Pixel object's coordinates.

Once a Java compiler compiles the source code shown in FIG. 5 into either binaries or bytecode as part of a graphics program, operating system 302 may run the binaries/bytecode on network device 200/interpreter 308.

Assume that David wants to extend the capabilities of graphical objects that have been instantiated in accordance with class definitions 402-408 during the graphics program execution. More specifically, David wants the program to update the appearance of a graphical object, within a GUI window, when interpreter 308 executes a set method of the object (see, for example, the set methods of Line class 404 and the set methods of Pixel class 406).

To extend the capabilities of graphical objects that are instantiated based on class definitions 402-408, David may modify each of class definitions 402-408, such that each of the set methods in class definitions 402-408 calls a draw method of the objects. As shown in FIG. 4, each of classes 402-408 inherits the draw method from their base class, Drawable 410.

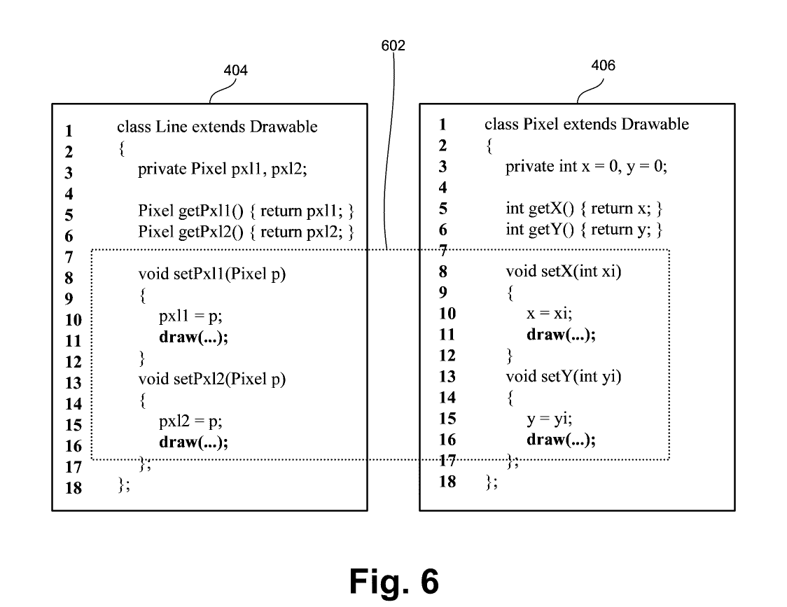

FIG. 6 shows exemplary changes to Line class 404 and Pixel class 406 for updating a Line and Pixel object that are displayed in the GUI window. As shown in bolded text in FIG. 6, each of the set methods in dotted rectangle 602 is edited to include a draw( )method. Because the same code is inserted in similar locations at each of Line and Pixel classes 404 and 406, the modification may be said to crosscut Line and Pixel classes 404 and 406. With the changes, when one of the set methods of a Line object or a Pixel object is invoked in the graphics program, the draw method may be executed. This may update the Line/Pixel object in the GUI window.

Although the changes illustrated in FIG. 6 are few, for larger systems that include many more classes and/or lines of code, making changes that crosscut multiple classes, as shown by dotted box 602, can be cumbersome, complicated, and expensive. In contrast, in an AOP language such as an AspectJ, the capabilities of objects (e.g., a Line object, Pixel object, etc.) can be extended without modifying classes 402-408. For example, in AspectJ, David may create/write a module, herein also referred to as an “aspect,” that may enable the graphical objects displayed in the GUI window to be updated whenever the original set methods defined in their classes are called.

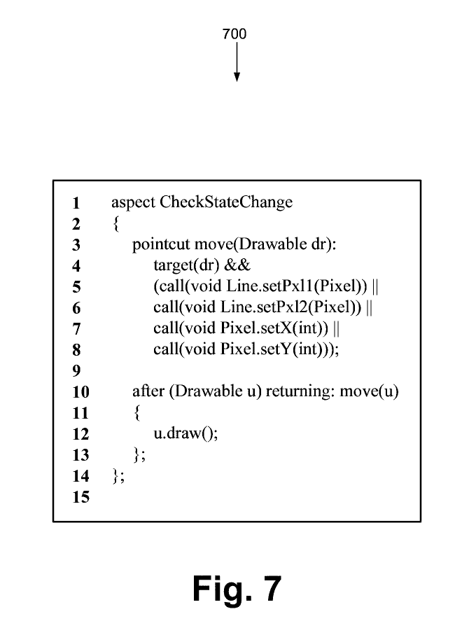

FIG. 7 shows an exemplary CheckStateChange aspect 700 written in AspectJ. CheckStateChange aspect 700 includes code for extending the capabilities of Line class 404 and Pixel class 406 without modifying, for example, the source code for Line class 404 or Pixel class 406. To generate bytecode or executable code with the extended capabilities, David may compile CheckStateChange aspect 700 together with class definitions 402 through 408.

As shown in FIG. 7, CheckStateChange aspect 700 may include a pointcut (see lines 3-8 of CheckStateChange aspect 700) and an advice (lines 10-13 of CheckStateChange aspect 700). “Pointcut” and “advice” are described below. For simplicity, CheckStateChange aspect 700 does not show other types of AspectJ expressions.

A pointcut in AspectJ may include expressions that identify points of execution in a program (e.g., the graphics program). As shown in FIG. 7, a pointcut (lines 3-8 of CheckStateChange aspect 700) may include a signature (e.g., “move(Drawable dr)” on line 3 of CheckStateChange aspect 700) and a body (lines 4-8 of CheckStateChange aspect 700).

The signature of a pointcut allows the pointcut to be referenced/or invoked within another statement within the same aspect. For example, in FIG. 7, at line 10, an advice statement references the pointcut defined at lines 3-8 of CheckStateChange aspect 700.

A body of a pointcut may identify execution points in a program. For example, lines 5-6 of CheckStateChange aspect 700 includes the body “target(dr) && (call(void Line.setPxl1(Pixel))∥ . . . ).” The combination “call(void Line.setPxl1(Pixel))∥call(void Line.setPxl2(Pixel))∥call (void Pixel.setX(int))∥call (void Pixel.setY(int))” may identify any point in the graphics program at which the setPxl1( . . . ) method of Line class 404, setPxl2( . . . ) method of Line class 404, setX( . . . ) method of Pixel class 406, or setY( . . . ) method of Pixel class 406 is called. The expression “target(dr)” (line 4 of FIG. 7) may expose the argument “dr” of “move(Drawable dr)” (line 3 of FIG. 7) to other statements in CheckStateChange aspect 700 and may allow the other statements to reference the contents of “dr.” For example, in FIG. 7, at line 10, the advice statement states “Drawable u.” The “u” may be reference the value of “dr.”

The advice (e.g., lines 10-13 of FIG. 7) may include code that is to be injected, during compilation of a program, at execution points (in the program) that are identified by pointcuts referenced in the advice. For example, the advice in CheckStateChange aspect 700 may inject “u.draw( )” (line 12 of FIG. 7) into the compiled graphics program at execution points that are identified by the pointcut move(u) (e.g., points at which the graphics program invokes setPxl1(Pixel) of Line class 404, setPxl2(Pixel) of Line class 404, setX(int) of Pixel class 406, and setY(int) of Pixel class 406).

Returning to FIG. 3, as described above, AOP compiler 306 may replace code, in a program being compiled, that is identified by one or more pointcuts. Depending on the implementation, AOP compiler 306 may perform the code replacement into the program before Java compilation takes place (e.g., the replacement occurs at source code level), at intermediate stage of the compilation (e.g., the replacement occurs when intermediate code is generated during the compilation) or at the final stages of the compilation (e.g., bytecode or executable code of the program are replaced by bytecode or executable code resulting from compiling an advice). AOP compiler 306 may output the compiled program to a file (e.g., a local file or a remote file).

Interpreter 308 may interpret source code and/or compiled code (e.g., bytecode). Examples of interpreter 308 may include a Lisp interpreter (e.g., Scheme interpreter), Perl interpreter, Java virtual machine, etc. In the following, for simplicity, interpreter 308 will be discussed in terms of a Java virtual machine.

Library 310 may include source code (e.g., code written by other programmers) that may be incorporated into or used by a program being compiled or interpreted. Examples of library 310 may include a C++ library, standard c library, Java packages and classes, etc.

Encryption aspect 312 may include an AOP program that implements encryption/decryption for serializing objects. Encryption aspect 312 may be compiled with another program (e.g., a Java communication program, I/O program for writing files, etc.) that is written either in the language in which encryption aspect 312 is implemented or in a language that is a subset of the language in which encryption aspect 312 is implemented.

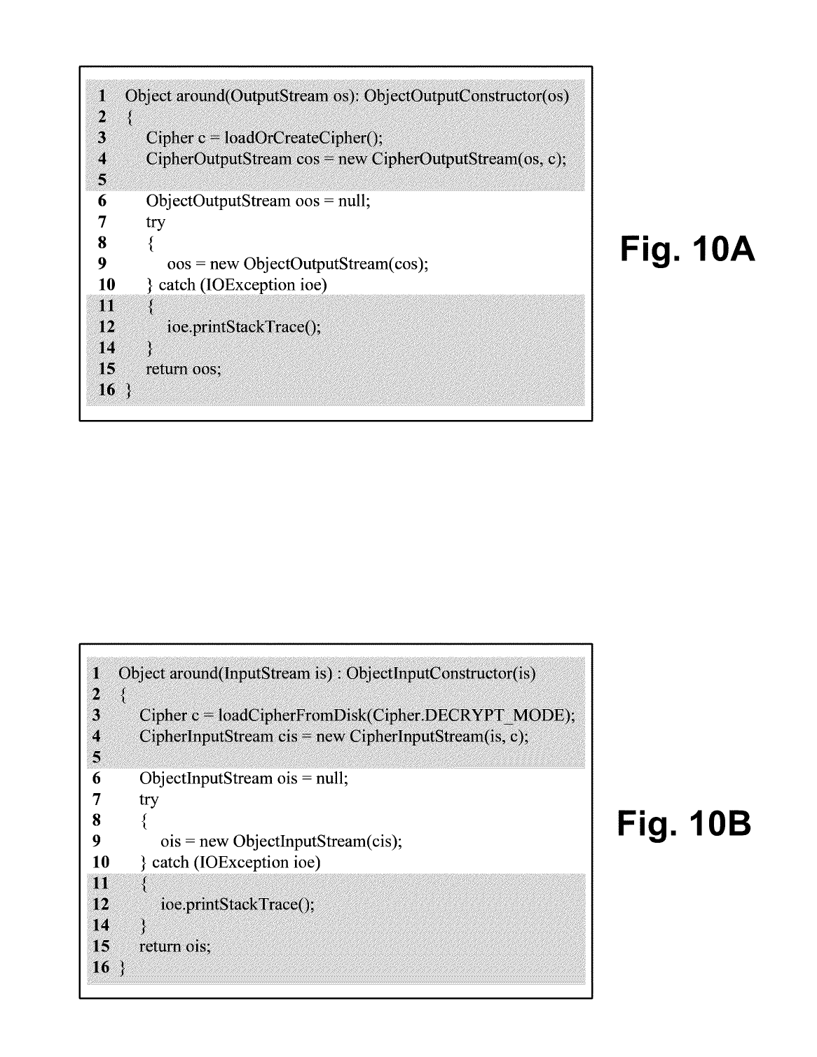

During the compilation, AOP compiler 306 may inject encryption code and decryption code specified by output advice 806 (see FIG. 10A) and input advice 808 (see FIG. 10B) into execution points that are identified by output pointcut 802 and input pointcut 804, respectively.

If encryption aspect 312 is compiled into bytecode, the resulting bytecode may be run on interpreter 308. Alternatively, if encryption aspect 312 is compiled into executable binaries, the binaries may be run on network device 200 via operating system 302.

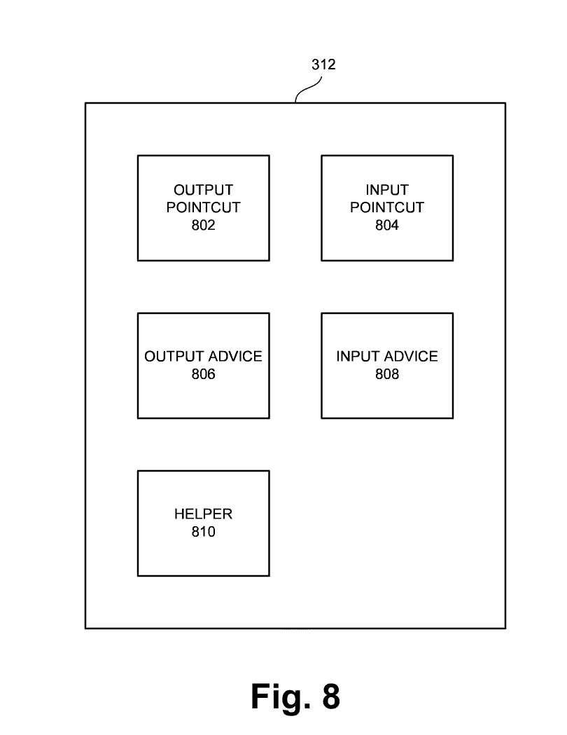

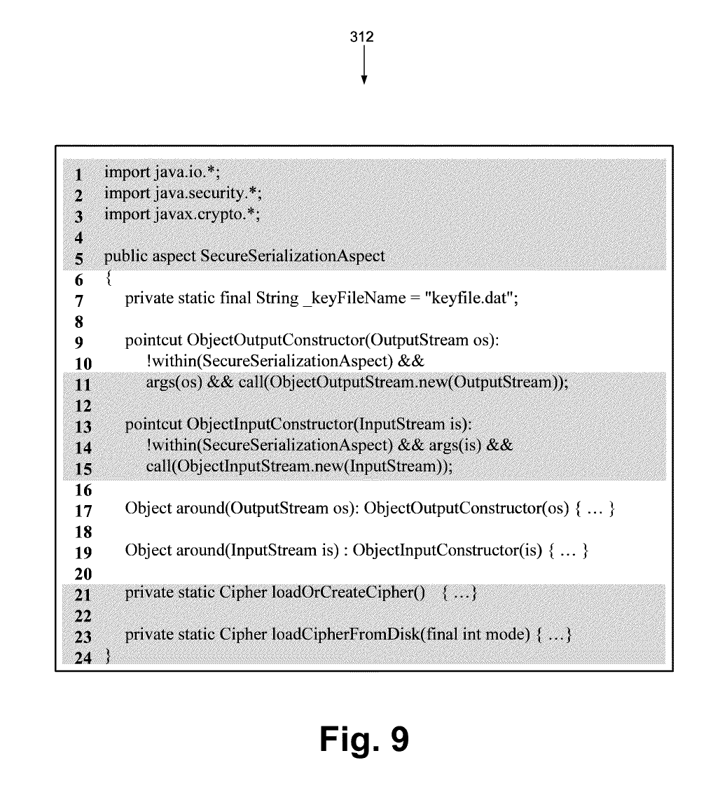

FIG. 8 is a block diagram of exemplary components of encryption aspect 312. FIG. 8 shows encryption aspect 312 of FIG. 8 implemented in AspectJ. As shown in FIG. 8, encryption aspect 312 may include output pointcut 802, input pointcut 804, output advice 806, input advice 808, and helper method 810. Depending on the implementation, encryption aspect 312 may include additional, fewer, different, or different arrangement of components than those illustrated in FIG. 8. FIG. 9 shows encryption aspect 312 of FIG. 8, implemented in AspectJ.

Output pointcut 802 may identify invocations of a constructor for creating an output component that is associated with de-serialization. For example, in FIG. 9, the SecureSerializationAspect aspect includes, at lines 9-11, ObjectOutput Constructor pointcut. The ObjectOutputConstructor pointcut identifies or matches invocations of ObjectOutputStream constructor that is called with an OutputStream argument. The pointcut also specifies that the identification be made in code that resides outside of SecureSerializationAspect (see line 10). Furthermore, the pointcut exposes an instance of OutputStream that is passed to the identified constructor as an argument. Consequently, the argument may be referenced in an advice in SecureSerializationAspect.

Returning to FIG. 8, input pointcut 804 may identify invocations of a constructor for creating an input component that is associated with serialization. For example, in FIG. 9, the SecureSerializationAspect aspect includes, at lines 13-15, ObjectInputConstructor pointcut. The ObjectInputConstructor pointcut identifies or matches invocations of ObjectInputStream constructor that is called with an InputStream argument. The pointcut also specifies that the identification be made in code that resides outside of SecureSerialization Aspect (see line 14). Furthermore, the pointcut exposes an instance of InputStream that is passed to the identified constructor as an argument. Consequently, the argument may be referenced in an advice in SecureSerializationAspect.

Output advice 806 may specify code that is to replace corresponding code at execution points identified by output pointcut 802. For example, SecureSerializationAspect of FIG. 9 includes, at line 17, an “around” advice with ObjectOutputConstructor pointcut. FIG. 10A shows exemplary details of the around advice.

In the around advice illustrated in FIG. 10A, a cipher is first either created or loaded from a file (see lines 3-4). In a different implementation, the cipher may be obtained from a different source, such as a network device. Subsequently, in FIG. 10A, a new CipherOutputStream is created and is passed as an argument into a constructor for ObjectOutputStream. Hence, ObjectOutputStream instance created in accordance with the around advice of FIG. 10A may provide an encrypted output stream for serialization.

Input advice 808 may specify code that is to replace corresponding code at execution points identified by input pointcut 804. For example, SecureSerializationAspect of FIG. 9 includes, at line 19, “around” advice with ObjectInputConstructor pointcut. FIG. 10B shows exemplary details of the around advice at line 19 of FIG. 9.

In the around advice illustrated in FIG. 10B, a cipher is either created or loaded from a file (see lines 3-4). In a different implementation, the cipher may be obtained from a different source, such as a network device. Subsequently, in FIG. 10B, a new CipherinputStream is created and is passed as an argument into a constructor for ObjectInputStream. Hence, the ObjectInputStream instance created in accordance with the around advice of FIG. 10A may provide an decrypted input stream for de-serialization.

When the SecureSerializationAspect of FIG. 9 is compiled with other relevant Java classes, AOP compiler 306 may replace standard constructors for ObjectOutputStream and ObjectInputStream with the encryption code and decryption code specified by the around advices illustrated in FIGS. 10A and 10B, at execution points that are identified by ObjectOutputConstructor pointcut and ObjectInputConstructor pointcut of FIG. 9.

Because the compiled program includes ObjectOutputStream and ObjectInputStream that are wrapped around CipherOutputStream and CipherinputStream, respectively, any data that is serialized/de-serialized during an execution of the program is encrypted/decrypted.

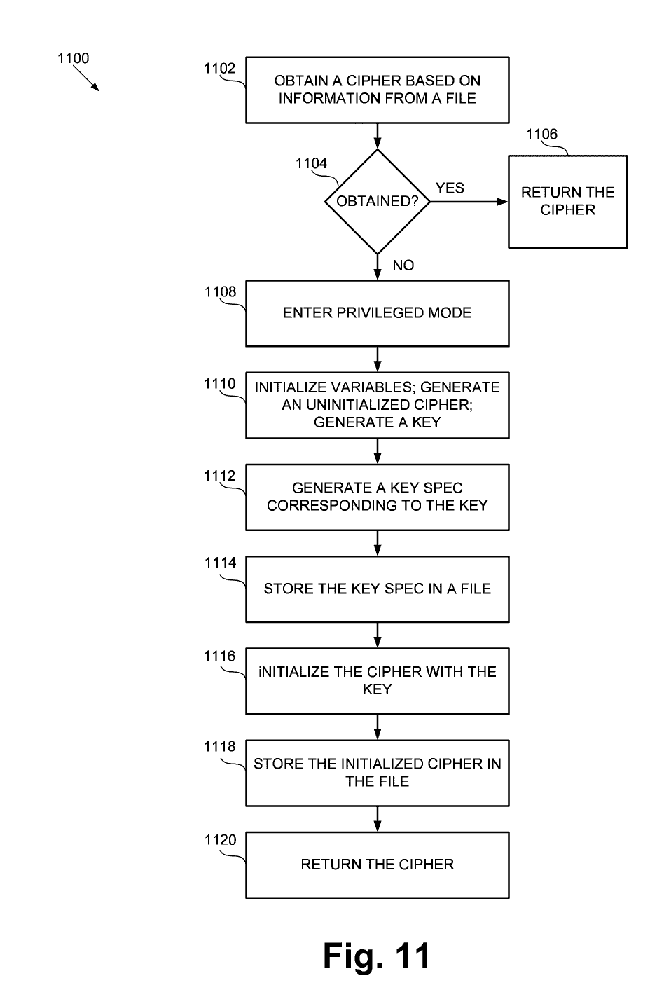

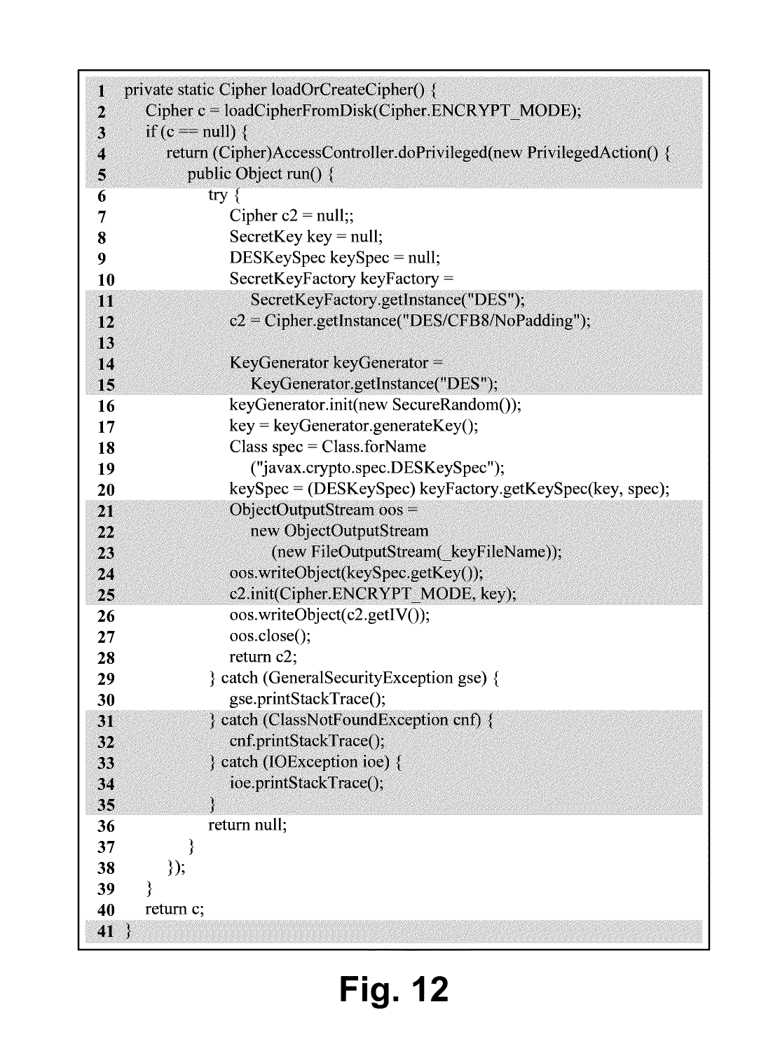

In FIGS. 10A and 10B, each of the around advices invokes a method (e.g., Cipher loadOrCreateCipher( )method at line 21 of SecureSerializationAspect of FIG. 9) for obtaining a cipher. FIG. 11 is a flow diagram of an exemplary process 1100 that is performed by the method for obtaining the cipher. FIG. 12 shows an exemplary Java program that implements the exemplary process 1100 of FIG. 11.

In FIG. 11, process 1100 may correspond to one or more processes (instances of a program) or threads that are performed by processor 202. Process 1100 may begin by attempting to obtain a cipher based on information from a file (block 1102). For example, as shown at line 2 in FIG. 12, loadCipherFromDisk may be invoked.

If the cipher is obtained (block 1104—YES), process 1100 may return the cipher to a method that invoked process 1100 (block 1106). For example, FIG. 12 shows the loadOrCreateCipher returning the obtained cipher to a caller method/program.

If the cipher is not obtained (block 1104—NO), process 1100 may enter a privileged mode for performing actions to generate an initialized cipher object (block 1108) (e.g., line 4 of FIG. 12). Subsequently, process 1100 may initialize variables needed for generating a cipher (block 1110) (e.g., lines 7-9 of FIG. 12) and generate an uninitialized cipher object (block 1108) (e.g., line 12 of FIG. 12).

Process 1100 may generate a key (block 1110). In FIG. 12, loadOrCreateCipher( ) generates the key by first instantiating the KeyGenerator (e.g., lines 14-15 of FIG. 12), initializing the KeyGenerator instance (e.g., line 16 of FIG. 12), and using the initialized instance to generate the key (e.g., line 17 of FIG. 12).

Process 1100 may generate a key specification that corresponds to the key generated at block 1110 (block 1112). A key specification may represent or describe a key. At lines 18-20 of FIG. 12, loadOrCreateCipher( )generates a key specification based on the key.

Process 1100 may store the key specification in a file for later use (block 1114) (e.g., lines 21-24 of FIG. 12).

Process 1100 may initialize the uninitialized cipher object generated at block 1108 using the key (e.g., line 25 of FIG. 12) (block 1116) and store the initialized cipher object in the same file in which the key specification is stored (block 1118) (e.g., line 26 of FIG. 12).

At block 1120, process 1100 may return the initialized cipher object to a process or a method that invoked process 1100 (block 1120) (e.g., line 28 of FIG. 12).

In FIG. 12, loadOrCreateCipher( ) may perform additional tasks or operations, such as exception handling (e.g., lines 29-35), closing the file that stores the key specification, etc. For simplicity, their description is omitted.

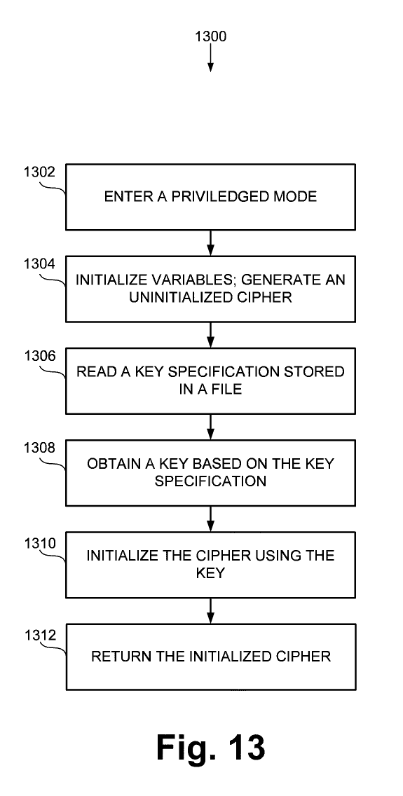

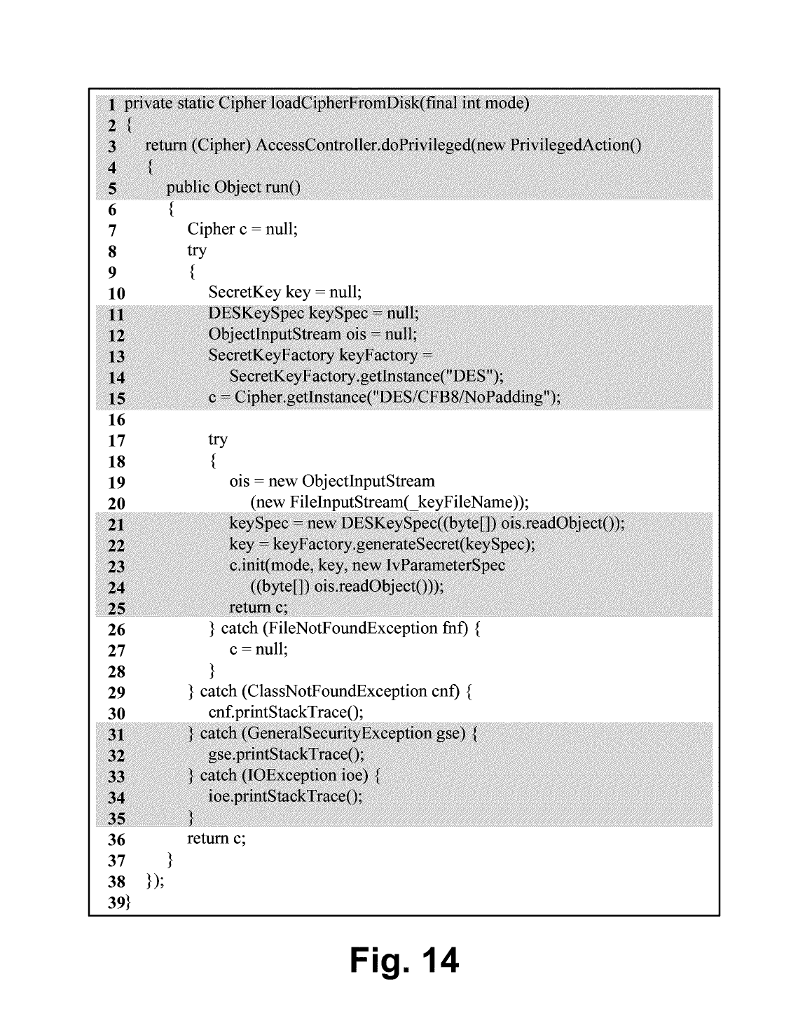

In the above description, at block 1102, process 1100 may attempt obtain an initialized cipher object based on information from a file. FIG. 13 is a flow diagram of an exemplary process 1300 for performing block 1102. FIG. 14 shows an exemplary Java program that implements the exemplary process 1300 of FIG. 13.

At block 1302, process 1300 may enter a privileged mode (e.g., line 3 of FIG. 14). Thereafter, process 1300 may initialize variables needed for loading a cipher (block 1304) (e.g., lines 10-14 of FIG. 14) and generate an uninitialized cipher object (block 1304) (e.g., line 15 of FIG. 14).

Process 1300 may read a key specification stored in a file (lock 1306). (e.g., lines 19-21 of FIG. 14), and generate a key based on the key specification (block 1308) (e.g., line 22 of FIG. 14).

Process 1300 may initialize the uninitialized cipher object using the key (block 1310) (lines 23 of FIG. 14) and return the initialized cipher object to process 1100 (e.g., loadorCreateCipher of FIG. 12).

In the foregoing description, a program that serializes or de-serializes data may be converted into a more secure program by extending the program with AOP encryption aspect 312. Extending the program with AOP encryption aspect 312 can obviate a typical problem in the object-oriented programming paradigm. For example, in an object-oriented programming environment, to add an encryption method that is common to a set of classes, a programmer may edit and compile the classes. When the number of classes to be modified is large, the upkeep and/or maintenance of the program can be cumbersome and expensive.

In contrast, to extend the program in accordance with the AOP paradigm, the programmer may specify the required encryption in a single aspect/module (i.e., AOP encryption aspect 312). Compiling the program with AOP compiler 308 may then generate a secure version of the program. Using the AOP paradigm to implement the encryption may be less cumbersome and expensive than relying solely on the object-oriented programming approach.

The foregoing description of implementations provides illustration, but is not intended to be exhaustive or to limit the implementations to the precise form disclosed. Modifications and variations are possible in light of the above teachings or may be acquired from practice of the teachings.

For example, while series of blocks have been described with regard to an exemplary processes illustrated in FIGS. 11 and 13, the order of the blocks may be modified in other implementations. In addition, non-dependent blocks may represent acts that can be performed in parallel to other blocks.

It will be apparent that aspects described herein may be implemented in many different forms of software, firmware, and hardware in the implementations illustrated in the figures. The actual software code or specialized control hardware used to implement aspects does not limit the invention. Thus, the operation and behavior of the aspects were described without reference to the specific software code—it being understood that software and control hardware can be designed to implement the aspects based on the description herein.

Further, certain portions of the implementations have been described as “logic” that performs one or more functions. This logic may include hardware, such as a processor, a microprocessor, an application specific integrated circuit, or a field programmable gate array, software, or a combination of hardware and software.

No element, act, or instruction used in the present application should be construed as critical or essential to the implementations described herein unless explicitly described as such. Also, as used herein, the article “a” is intended to include one or more items. Further, the phrase “based on” is intended to mean “based, at least in part, on” unless explicitly stated otherwise.

What is claimed is:

1. A method comprising:
reading an aspect-oriented program;
identifying, within a program, by one or more processors, code for instantiating a stream object based on the aspect-oriented program;
replacing within the program, by the processors, the code for instantiating the stream with code for instantiating a secure stream object; and
generating, by the processors, a compiled program from a result of the replacement.

2. The method of claim 1, wherein the generating the compiled program includes:
generating machine-executable code; or
generating bytecode for an interpreter.

3. The method of claim 1, wherein the identifying the code for instantiating the stream object includes:
identifying a constructor for an object input stream object.

4. The method of claim 1, wherein the instantiating the secure stream object includes:
instantiating a cipher output stream object.

5. The method of claim 4, wherein the instantiating the cipher output stream object includes one of:
obtaining a cipher object from a network;
loading a cipher object from a file; or
generating a new cipher object.

6. The method of claim 1, wherein reading the aspect-oriented program includes reading an aspect that specifies conditions for identifying the code for instantiating the stream object.

7. The method of claim 6, wherein the reading the aspect includes:
reading an expression that stipulates the identified code be outside of the aspect.

8. The method of claim 6, wherein the reading the aspect includes:
reading an expression that stipulates the identified code be a stream constructor.

9. The method of claim 1, wherein the identifying includes:
reading a Java program.

10. A device comprising:
a processor configured to:
read an aspect;
identify, within a program, code for instantiating an object output stream object based on the aspect;
replace, within the program, the code for instantiating the object output stream object with code for instantiating a secure object output stream object;
generate a compiled program from code obtained by replacing, in the program, the code for instantiating the object output stream object with the code for instantiating the secure object output stream object.
write the compiled program to a file.

11. The device of claim 10, wherein the program code includes one of:
compiled code; or
source code.

12. The device of claim 10, wherein the program includes:
a Java program, and wherein the aspect includes an AspectJ aspect.

13. The device of claim 10, wherein the aspect includes:
a pointcut that identifies a call to a constructor for instantiating the object output stream object; and
an advice that specifies the code for instantiating the secure object output stream object;

14. The device of claim 13, wherein the pointcut includes expressions for indicating that the code for instantiating the object output stream object is not to be replaced with the code for instantiating secure output stream object when the code for instantiating the object output stream object is outside of the aspect.

15. The device of claim 13, wherein the pointcut includes instructions for exposing an argument of the constructor.

16. The device of claim 15, wherein the secure object output stream object includes an object output stream object including an encryption output stream object;

17. The device of claim 10, wherein the generated compiled program includes one of:
Java bytecode or machine-executable code.

18. A computer-readable storage unit comprising machine-readable instructions, the machine-readable instructions comprising:
an aspect, including:
a pointcut that identifies code, outside of the aspect, for instantiating an object output stream object; and
an advice that includes replacement code for the code identified by the pointcut, the replacement code including code for instantiating a secure object output stream object.

19. The computer-readable storage unit of claim 18, wherein the secure object output stream object includes:
an object output stream object that includes a cipher output stream object.

20. The computer-readable storage unit of claim 19, wherein the cipher output stream object includes a cipher.
